(19) United States
(12) Patent Application Publication
(10) Pub. No.: US 2025/0084002 A1
(43) Pub. Date: Mar. 13, 2025

(54) A cementitious composition, a composite material, and a method of manufacturing the composite material

(71) Applicant: Teknologian tutkimuskeskus VTT Oy, Espoo (FI)

(72) Inventors: Tandré Oey, Espoo (FI); Tapio Vehmas, Espoo (FI)

(21) Appl. No.: 18/723,481

(22) PCT Filed: Dec. 20, 2022
(86) PCT No.: PCT/FI2022/050856

§ 371 Date: Jun. 24, 2024

(30) Foreign Application Priority Data
Dec. 22, 2021 (FI) 20216322

(51) Int. Cl. C04B 28/14; C04B 14/28; C04B 22/08; C04B 24/06; C04B 28/08

(52) U.S. Cl. CPC C04B 28/14; C04B 14/28; C04B 22/085; C04B 24/06; C04B 28/08; C04B 2201/50

(57) ABSTRACT

According to an example aspect of the present invention, there is provided a composition comprising: a cementitious material; an alpha-hydroxy acid; and at least 4 wt-% of a salt of an alkaline earth metal, calculated from the total dry matter of the cementitious material.

### FIELD

The present invention relates to compositions that are used in the manufacturing of concrete.

### BACKGROUND

Current methods of producing high-strength concrete can be costly or introduce complications relating to workability and sustainability. Likewise, sustainability of normal-strength concrete is limited by low reactivity of the alternative materials used to reduce the concrete's environmental footprint.

Citric acid and calcium nitrate are well-known to slow down and speed up cement hydration reactions, respectively. Such effects remain only partially understood. However, it is generally accepted that they primarily modify early cement hydration (before 3 days), with the mature mechanical properties (i.e. compressive strength from 7 days onward) largely being controlled by the composition of the basic cementitious mixture, such as cement reactivity, fineness and water-cement ratio.

Typical methods to increase concrete compressive strength involve reducing the water-cement ratio, or increasing the inherent reactivity and fineness of the cement. These methods can prove costly and introduce problems in concrete workability.

Currently, producing high-strength concrete reduces its sustainability because of the requirement for increased cement content.

Similarly, efforts to improve sustainability of normal-strength concrete are limited by the low reactivity of the materials used to replace cement.

Existing methods to enhance concrete strength almost uniformly rely on changing mixture proportioning, such as increasing cement use.

Aside from sustainability concerns, the known solutions may also introduce complications with other concrete properties like workability.

### SUMMARY OF THE INVENTION

The invention is defined by the features of the independent claims. Some specific embodiments are defined in the dependent claims.

According to a first aspect of the present invention, there is provided a cementitious composition comprising: a cementitious material; an alpha-hydroxy acid; and at least 4 wt-% of a salt of an alkaline earth metal, calculated from the total dry matter of the cementitious material.

According to a second aspect of the present invention, there is provided a composite material, comprising the cementitious composition according to the first aspect.

According to a third aspect of the present invention, there is provided a method of preparing a composite material, such as concrete, comprising: dissolving an alpha-hydroxy acid and a salt of an alkaline earth metal in water to obtain an aqueous solution; mixing the obtained aqueous solution with a cementitious material and aggregate material to obtain a hardenable mixture; and allowing the hardenable mixture to harden and set to obtain a composite material, wherein the amount of the salt of an alkaline earth metal in the composite material is at least 4 wt-%, calculated from the total dry matter of the cementitious material.

According to a fourth aspect of the present invention, there is provided use of the cementitious composition according to first aspect in the manufacturing of concrete.

According to a fifth aspect of the present invention, there is provided use of a composition comprising an alpha-hydroxy acid and a salt of an alkaline earth metal in combination with a cementitious material in the manufacturing of concrete, wherein the amount of the salt of an alkaline earth metal is at least 4 wt-%, calculated from the total dry matter of the cementitious material.

Various embodiments of the first, second, third, fourth or fifth aspect may comprise one or more features from the following bulleted list:
The cementitious composition comprises at least 50 wt-%, such as at least 80 wt-% of a cementitious material, of total dry matter of the cementitious composition.
The cementitious material comprises any of the following cement compositions: CEM I to CEM V and their mixtures, as defined in European cement standard EN 197-1 Cement—Part 1: “Composition, specifications and conformity criteria for common cements”.
The cementitious material comprises or consists of Portland cement.
The cementitious material comprises less than 10 wt-%, such as less than 5 wt-%, for example less than 0.1 wt-% or does not comprise any sulphoaluminate cements, such as calcium sulphoaluminate cements, of total dry matter of the cementitious material.
The cementitious material comprises less than 10 wt-%, such as less than 5 wt-%, for example less than 0.1 wt-% or does not comprise any aluminous cements or calcium aluminate cements, of total dry matter of the cementitious material.
The cementitious material comprises one or more of the following: blast furnace slag, fly ash and limestone, and derivatives and mixtures thereof.
The cementitious material comprises at least 5 wt-%, such as at least 10 wt-% blast furnace slag, of total dry matter of the cementitious material.
The cementitious material comprises at least 5 wt-%, such as at least 10 wt-% fly ash, of total dry matter of the cementitious material.
The cementitious material comprises at least 5 wt-%, such as at least 10 wt-% limestone, of total dry matter of the cementitious material.
The cementitious material comprises at least 10 wt-%, such as at least 20 wt-%, for example at least 30 wt-% of blast furnace slag, fly ash and/or limestone, of total dry matter of the cementitious material.
The alpha-hydroxy acid comprises a dicarboxylic acid or a tricarboxylic acid.
The alpha-hydroxy acid comprises one or more acids selected from the following group: citric acid, tartaric acid, and mixtures thereof.
The alpha-hydroxy acid consists of citric acid.
The amount of the alpha-hydroxy acid is at least 0.1 wt-%, such as 0.1 to 1 wt-% of the total dry matter of the cementitious material.
The amount of the alpha-hydroxy acid is 0.1 to 0.2 wt-%, such as 0.12 to 0.16 wt-% of the total dry matter of the cementitious material.
The salt of an alkaline earth metal comprises or consists of a calcium salt.
The calcium salt comprises one or more salts selected from the following group: calcium nitrate, calcium chloride, and mixtures thereof.
The calcium salt consists of calcium nitrate.
The amount of the calcium salt is at least 5 wt-%, such as at least 6 wt-%, or 5 to 15 wt-% of the total dry matter of the cementitious material.
The cementitious composition is hardenable by mixing it with water.
The cementitious composition comprises: at least 50 wt-% of a cementitious material, of total dry matter of the composition; at least 0.1 wt-% of citric acid; and at least 4 wt-% of a calcium salt, the amounts of citric acid and calcium salt being calculated from the total dry matter of the cementitious material.
The cementitious composition does not comprise any urea.
The aggregate material comprises one or more of the following group: sand, gravel, and mixtures thereof.
The composite material is in the form of hardened or unhardened concrete or mortar.
The composite material is in the form of unhardened concrete.
The composite material is in the form of hardened concrete.
The composite material does not comprise any urea.
Urea is not used in the manufacturing of the composite material.
The composite material has a compressive strength of at least 30 MPa, such as at least 40 MPa, such as at least 50 MPa, after 7 days from onset of hardening.
The composite material has a compressive strength of at least 30 MPa, such as at least 40 MPa, such as at least 50 MPa, after 28 days from onset of hardening.
The composite material has a compressive strength of at least 30 MPa, such as at least 40 MPa, such as at least 50 MPa, after 90 days from onset of hardening.
The alpha-hydroxy acid comprises citric acid, and the salt of an alkaline earth metal comprises calcium nitrate.
The cementitious material comprises blast furnace slag.
The cementitious material consists of Portland cement and blast furnace slag.
The alpha-hydroxy acid comprises citric acid, the salt of an alkaline earth metal comprises calcium nitrate, and the cementitious material comprises blast furnace slag and Portland cement.

### Advantages of the Invention

The use of the present compositions may enhance concrete compressive strength and have the potential to reduce costs and quality control issues currently associated with production of high-strength concrete.

In some embodiments, the present invention provides a more sustainable normal-strength concrete that contains less cement binder.

In some embodiments, the present invention provides an auxiliary effect of reducing potential damage caused by excessive heat from cement hydration.

In some embodiments, the present invention may be able to mitigate several mechanisms of long-term deterioration.

In some embodiments, the invention provides a new combination of calcium nitrate and citric acid that may improve the compressive strength of concrete by enhancing the degree of reaction of the cement binder component.

This may enable the concrete to achieve a desired performance or sustainability by making more efficient use of the reactive cement it contains.

Cement produces significant carbon emissions. The present invention may maximize the inherent reactivity of cement, to facilitate minimizing the amount of cement needed.

The present invention may improve sustainability of normal-strength concrete.

One key feature of the present composition is that it may achieve benefits without changes to a given concrete's mixture proportions.

The present invention may enable reduction of cement content or cementitious material content of concrete, such as by at least 5 wt-%, such as by at least 10 wt-% in a hardenable cementitious composition.

Some embodiments of the invention may enable increasing the compressive strength of concrete by 50%, when compared to a concrete with a similar composition but not containing any alpha-hydroxy acid nor any salt of an alkaline earth metal.

### BRIEF DESCRIPTION OF THE DRAWINGS

FIGS. 1 and 2 show experimental results for compositions in accordance with at least some embodiments of the present invention.

### EMBODIMENTS

### Definitions

In the present context, the term “cement” may refer to any cementitious material that is capable of functioning as a hydraulic binder in concrete.

Portland cement is the most common type of cement in general use around the world as a basic ingredient of concrete.

In the present context, the term “concrete” typically refers to hardened concrete while the term “fresh concrete” refers to unhardened or at least partially unhardened concrete.

Compressive strength typically is determined after 7 or 28 or 90 days' storage at +20° C. in air of 100% relative humidity.

Some embodiments of the present invention provide new compositions, such as chemical admixtures, to increase the compressive strength of concrete structures.

In some embodiments, the invention provides a combined use of an alpha-hydroxy acid and a salt of an alkaline earth metal for strength enhancement of concrete, for example at a constant cement content.

The present invention may allow one to achieve a higher compressive strength while using the mixture proportions of a normal-strength concrete.

Particular embodiments of the invention may avoid use of finer, more reactive cements and/or avoid reduction of the water-cement ratio.

It may become possible to achieve a comparable compressive strength to normal concrete while using lower amounts of materials like cement, particularly Portland cement, that have a high environmental footprint.

For example, the present invention may make it possible to successfully replace at least a part of the hydraulic binder with inert or more inert mineral fillers.

The present invention may also enable increasing the water-cement ratio w/c, for example above 0.5, such as above 0.6, for example above 0.7.

The combination of an alpha-hydroxy acid and a salt of an alkaline earth metal may moderate the rapid early cement hydration reactions, allowing the cement to ultimately achieve a greater degree of reaction and, accordingly, a higher compressive strength.

The new compositions provided here may provide an alternate way to increase mature compressive strength of concrete, without changing the cement type or the water-cement ratio.

The mechanism leading to the advantageous strength properties may involve increase of the degree of reaction of the cement, advantageously across multiple cement types, finenesses, and strength classes.

In one embodiment, the cementitious composition comprises a cementitious material, an alpha-hydroxy acid and a salt of an alkaline earth metal.

In the present context, the term “cementitious composition” typically refers to a composition in which the main component is a cementitious material, such as a cement.

Preferably, the amount of cementitious material in the cementitious composition is at least 50 wt-%, such as at least 70 wt-%, for example at least 90 wt-%, for example at least 92 w-% of total dry matter of the cementitious composition.

Standard cement compositions are defined in European cement standard EN 197-1 Cement—Part 1: “Composition, specifications and conformity criteria for common cements”, which defines 27 distinct common cement compositions and their constituents. These 27 cement compositions are grouped into the following categories:
CEM I Portland cement (>95% clinker)
CEM II Portland-composite cement (65-94% clinker)
CEM III Blastfurnace cement (5-64% clinker)
CEM IV Pozzolanic cement (45-89% clinker)
CEM V Composite cement (20-64% clinker)

The cementitious material may comprise one or more cements selected from the following group: Portland cement, Finnish cements, such as Plussementti, and derivatives and mixtures thereof.

The cementitious material may comprise any of the following cement compositions: CEM I to CEM V, and mixtures thereof.

In some embodiments, the cementitious material comprises a Type I cement, such as a Finnish Type 1 cement.

In some embodiments, the cementitious material comprises a Type II cement, such as a Finnish Type II cement.

In an embodiment, the cementitious material comprises or consists of Portland cement.

The cementitious material may comprise Portland cement, for example at least 50 wt-% Portland cement, of total dry matter of the cementitious material.

In an embodiment, the cementitious material comprises one or more of the following: blast furnace slag, fly ash and limestone, and derivatives and mixtures thereof.

In an embodiment, the cementitious material comprises at least 5 wt-%, such as at least 10 wt-%, for example at least 30 wt-% blast furnace slag, of total dry matter of the cementitious material.

In an embodiment, the cementitious material comprises at least 5 wt-%, such as at least 10 wt-% fly ash, of total dry matter of the cementitious material.

In an embodiment, the cementitious material comprises at least 5 wt-%, such as at least 10 wt-% limestone, of total dry matter of the cementitious material.

In an embodiment, the cementitious material comprises at least 10 wt-%, such as at least 20 wt-%, for example at least 30 wt-% of blast furnace slag, fly ash and/or limestone, of total dry matter of the cementitious material.

In one embodiment, the alpha-hydroxy acid comprises a dicarboxylic acid or a tricarboxylic acid.

The alpha-hydroxy acid may be selected from the following group: citric acid, tartaric acid, glycolic acid, lactic acid, malic acid, and mixtures thereof.

Preferably, the alpha-hydroxy acid is citric acid, tartaric acid, or a mixture thereof.

In an embodiment, the alpha-hydroxy acid consists of citric acid.

Preferably, the amount of the alpha-hydroxy acid is at least 0.1 wt-%, such as at least 0.2 wt-%, for example 0.1 to 0.5 wt-%, or 0.1 to 1 wt-% of the total dry matter of the cementitious material.

The salt of an alkaline earth metal may be a salt of calcium or magnesium, or a mixture thereof.

In an embodiment, the calcium salt comprises one or more salts selected from the following group: calcium nitrate, calcium chloride, and mixtures thereof.

In an embodiment, the calcium salt consists of calcium nitrate.

In an embodiment, the amount of the salt of an alkaline earth metal, such as a calcium salt, is at least 4 wt-%, such as at least 5 wt-%, such as at least 6 wt-%, or 4 to 15 wt-%, or 6 to 10 wt-%, of the total dry matter of the cementitious material.

The calcium salt may be calcium nitrate, calcium chloride, or any hydrate or mixture thereof.

The calcium salt may be capable of promoting precipitation of carbonate salts during hydration of the binder.

The calcium salt may be capable of participating in chelation reactions during hydration of the binder.

In one embodiment, the cementitious composition comprises a cementitious material; an alpha-hydroxy acid; and at least 4 wt-% of a salt of an alkaline earth metal, calculated from the total dry matter of the cementitious material, wherein the cementitious material comprises or consists of Portland cement, wherein the amount of the alpha-hydroxy acid is at least 0.1 wt-% of the total dry matter of the cementitious material, and wherein the salt of an alkaline earth metal comprises or consists of a calcium salt.

In one embodiment, the cementitious composition comprises at least 0.1 wt-% of the alpha-hydroxy acid; and at least 4 wt-% of the calcium salt, of the total dry matter of the cementitious material.

In one embodiment, the cementitious composition comprises a cementitious material, citric acid, and calcium nitrate, preferably the cementitious composition comprises or consists of a cementitious material, at least 0.1 wt-% citric acid, and at least 4 wt-% calcium nitrate, the amounts being calculated from the total dry matter of the cementitious material.

In some embodiments, the cementitious composition comprises 4 to 6 wt-% calcium nitrate, and 0.1 to 0.2 wt-%, such as 0.125 to 0.15 wt-% citric acid, calculated from the total dry matter of the cementitious material.

In some embodiments, the cementitious composition comprises 4 to 6 wt-% calcium nitrate and 0.1 to 0.2 wt-% tartaric acid, calculated from the total dry matter of the cementitious material.

Typically the cementitious composition is hardenable by mixing it with water.

The cementitious composition may be used in the manufacturing of solid concrete structures.

The present combination of an alpha-hydroxy acid and a salt of an alkaline earth metal may regulate the reaction rate of the cementitious material, making it more even over time, to achieve an ultimately higher degree of reaction in the long-term.

Such a function may allow for improved strength for a given cement content.

Possible mechanisms contributing to at least some of the effects observed in some embodiments are promotion of nucleation or precipitation, and/or calcium chelation prolonging the growth period of hydration products. The present invention is however not limited to any theory or possible mechanism.

In the following, a composite material according to some embodiments is described.

In some embodiments, the composite material comprises the above described cementitious composition and additionally aggregate material.

The aggregate material may comprise one or more of the following group: sand, gravel, and mixtures thereof.

Typically the composite material is in the form of hardened or unhardened concrete or mortar.

The composite material may be in the form of a cementitious paste, mortar, or concrete.

The composite material may be in the form of a flowable paste.

Alternatively the composite material may be in the form of a solid or hardened material.

The composite material may have a compressive strength of at least 30 MPa, such as at least 40 MPa, such as at least 50 MPa, such as at least 80 MPa, preferably after 28 days, calculated from the mixing of the components of the composite material and thus from the onset of the hardening reactions.

The water-cementitious material ratio (w/c) in the composite material may be at least 0.4, such as at least 0.5, for example in the range 0.5 to 0.65, or 0.4 to 0.8.

In the following we describe methods of preparing a composite material according to some embodiments.

In an embodiment, a method of preparing a composite material, such as concrete, comprises: dissolving an alpha-hydroxy acid and a salt of an alkaline earth metal in water to obtain an aqueous solution; mixing the obtained aqueous solution with a cementitious material and aggregate material to obtain a hardenable mixture; and allowing the hardenable mixture to harden and set to obtain a composite material. Preferably, the amount of the salt of an alkaline earth metal is at least 4 wt-%, calculated from the total dry matter of the cementitious material.

The alpha-hydroxy acid typically comprises citric acid. The salt of an alkaline earth metal typically comprises calcium nitrate.

The cementitious composition may be used in or for the manufacturing of concrete.

A composition comprising an alpha-hydroxy acid and a salt of an alkaline earth metal may be used in combination with a cementitious material in the manufacturing of concrete. Typically the amount of the salt of an alkaline earth metal is at least 4 wt-%, calculated from the total dry matter of the cementitious material.

In said use, the alpha-hydroxy acid may comprise citric acid and the salt of an alkaline earth metal may comprise calcium nitrate.

In said use, the cementitious material may comprise a cement and additionally blast furnace slag.

### EXAMPLES

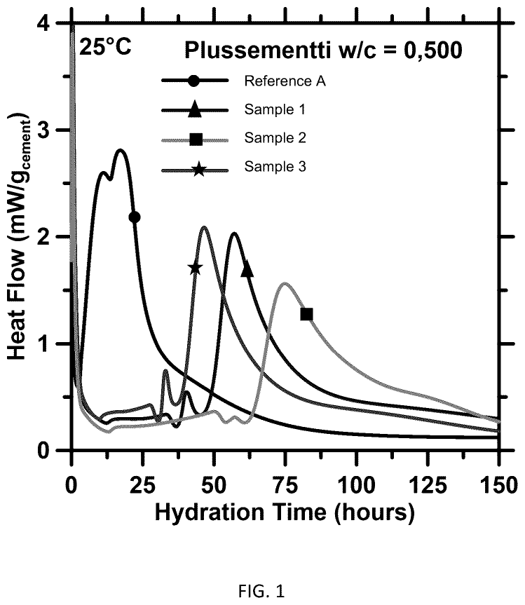

FIG. 1 shows heat flow as a function of hydration time for the following samples:

Reference A is a reference sample comprising Plussementti, which is a Finnish cementitious material comprising Portland cement and about 30 wt-% blast furnace slag. The w/c ratio was 0.5.

Sample 1 comprises Plussementti, and 0.15 wt-% citric acid and 6.0 wt-% calcium nitrate, of total dry matter of Plussementti.

Sample 2 comprises Plussementti, and 0.15 wt-% citric acid and 4.0 wt-% calcium nitrate, of total dry matter of Plussementti.

Sample 3 comprises Plussementti, and 0.125 wt-% citric acid and 6.0 wt-% calcium nitrate, of total dry matter of Plussementti.

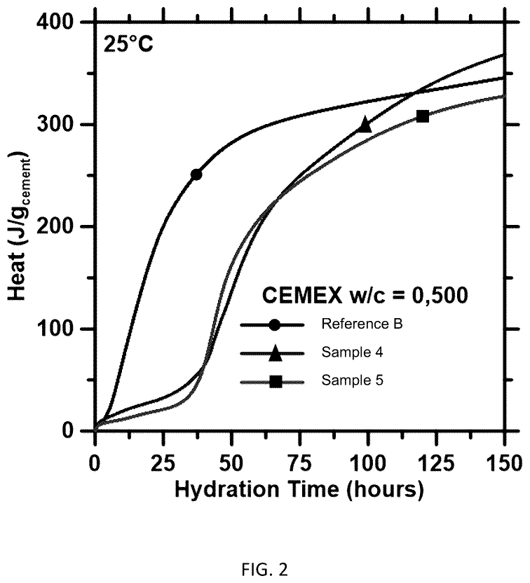

FIG. 2 shows heat as a function of hydration time for the following samples:

Reference B is a reference sample comprising CEMEX, which is a cementitious material comprising Portland cement, limestone and gypsum. The w/c ratio was 0.5.

Sample 4 comprises CEMEX, and 0.15 wt-% citric acid and 6.0 wt-% calcium nitrate, of total dry matter of CEMEX.

Sample 5 comprises CEMEX, and 0.15 wt-% tartaric acid and 6.0 wt-% calcium nitrate, of total dry matter of CEMEX.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

### INDUSTRIAL APPLICABILITY

The present invention is industrially applicable at least in the manufacturing of concrete.

1. A cementitious composition comprising:
a cementitious material;
an alpha-hydroxy acid; and
at least 4 wt-% of a salt of an alkaline earth metal, calculated from the total dry matter of the cementitious material.

2. The cementitious composition according to claim 1, comprising at least 50 wt-% of the cementitious material, calculated from the total dry matter of the cementitious composition.

3. The cementitious composition according to claim 1, wherein the cementitious material comprises one or more of the following cement compositions: CEM I to CEM V, or their mixtures, as defined in European cement standard EN 197-1.

4. The cementitious composition according to claim 1, wherein the cementitious material comprises or consists of Portland cement.

5. The cementitious composition according to claim 1, wherein the cementitious material comprises one or more materials selected from the group consisting of blast furnace slag, fly ash, and limestone, and derivatives, and mixtures thereof.

6. The cementitious composition according to claim 1, wherein the cementitious material comprises at least 5 wt-% blast furnace slag, calculated from the total dry matter of the cementitious material.

7. The cementitious composition according to claim 1, wherein the cementitious material comprises at least 5 wt-% fly ash, calculated from the total dry matter of the cementitious material.

8. The cementitious composition according to claim 1, wherein the cementitious material comprises at least 5 wt-% limestone, calculated from the total dry matter of the cementitious material.

9. The cementitious composition according to claim 1, wherein the cementitious material comprises at least 10 wt-%, of blast furnace slag, fly ash and/or limestone, of calculated from the total dry matter of the cementitious material.

10. The cementitious composition according to claim 1, wherein the alpha-hydroxy acid comprises a dicarboxylic acid or a tricarboxylic acid.

11. The cementitious composition according to claim 1, wherein the alpha-hydroxy acid comprises one or more acids selected from the group consisting of citric acid, tartaric acid, and mixtures thereof.

12. The cementitious composition according to claim 1, wherein the amount of the alpha-hydroxy acid is at least 0.1 wt-% of the total dry matter of the cementitious material.

13. The cementitious composition according to claim 1, wherein the salt of an alkaline earth metal comprises or consists of a calcium salt selected from the group consisting of calcium nitrate, calcium chloride, and mixtures thereof.

14. The cementitious composition according to claim 13, wherein the calcium salt consists of calcium nitrate.

15. The cementitious composition according to any of the preceding claims, wherein the amount of the calcium salt is at least 5 wt-% of the total dry matter of the cementitious material.

16. (canceled)

17. The cementitious composition according to claim 1, the cementious composition comprising:
at least 50 wt-% of the cementitious material, calculated on the total dry matter of the cementitious composition;
at least 0.1 wt-% of citric acid; and
at least 4 wt-% of a calcium salt,
the amounts of citric acid and the calcium salt being calculated from the total dry matter of the cementitious material.

18. A composite material, comprising the cementitious composition according to claim 1 and aggregate material.

19. The composite material according to claim 18, wherein the aggregate material comprises one or more members selected from the group consisting of sand, gravel, and mixtures thereof.

20. The composite material according to claim 18, wherein the composite material is in the form of hardened or unhardened concrete or mortar.

21. The composite material according to claim 18, the composite material having a compressive strength of at least 30 MPa, after 28 days from onset of hardening.

22. A method of preparing a composite material, the method comprising:
dissolving an alpha-hydroxy acid and a salt of an alkaline earth metal in water to obtain an aqueous solution;
mixing the obtained aqueous solution with a cementitious material and aggregate material to obtain a hardenable mixture; and
allowing the hardenable mixture to harden and set to obtain a composite material, wherein the amount of the salt of an alkaline earth metal in the composite material is at least 4 wt-%, calculated from the total dry matter of the cementitious material.

23. The method according to claim 22, wherein the alpha-hydroxy acid comprises citric acid, and the salt of an alkaline earth metal comprises calcium nitrate.

24-27. (canceled)
